(19) United States
(12) Patent Application Publication
(10) Pub. No.: US 2011/0214218 A1
(43) Pub. Date: Sep. 8, 2011

(54) GARMENT WITH AN INSPECTION PORT

(75) Inventors: Stephen Bonamer, Broadview Heights, OH (US); Joe Luic, Olmsted Twp., OH (US)

(73) Assignee: FIRE-DEX, LLC, Medina, OH (US)

(21) Appl. No.: 12/716,702

(22) Filed: Mar. 3, 2010

(51) Int. Cl. A62B 17/00; A41D 13/00; A41D 3/02; A41D 1/00; A41D 27/00

(52) U.S. Cl. 2/81; 2/82; 2/87; 2/93; 2/243.1

(57) ABSTRACT

A garment includes a moisture barrier layer and a thermal barrier layer connected to the moisture barrier layer by at least one seam extending along a perimeter portion of the thermal barrier layer and enclosing a space between the moisture barrier layer and the thermal barrier layer. The garment also has an inspection port in the thermal barrier layer, the inspection port spaced apart from the perimeter portion of the thermal barrier layer, wherein the space between the moisture barrier layer and the thermal barrier layer is accessible through the inspection port.

### FIELD OF THE INVENTION

The application relates generally to clothing, and more particularly to protective garments.

### DESCRIPTION OF THE RELATED ART

Protective garments, for example, those worn by firefighters, have multiple layers of material. Typical protective garments have an outer shell connected to an inner liner. The outer shell is usually a durable, waterproof or water resistant material and the inner liner is usually composed of a moisture barrier layer and a thermal barrier layer. The moisture barrier layer usually is disposed between the outer shell and the thermal barrier layer.

The structural integrity of the inner liner is very important to the safety of the person wearing the garment. A breach in or damage to the moisture barrier layer or the thermal barrier layer can allow the firefighter wearing the garment to be injured or harmed. For example, a hole in the inner liner could allow heat or steam to pass through the liner and burn the firefighter. A hole in the moisture layer also could allow water to pass into the thermal liner causing the garment to become heavy from the weight of the absorbed water.

The inner liner can be damaged in many ways. For example, the inner liner can be damaged by debris or other material that slips into the space between the moisture barrier layer and the thermal barrier layer and/or between the inner liner and the outer shell. The inner liner also can be damaged by the surrounding environment, for example, when the firefighter is fighting a blaze. Also, general wear and environmental abrasions can damage the moisture barrier layer and thermal barrier layer on both sides of each fabric.

It is therefore necessary to inspect both the moisture barrier layer and the thermal barrier layer periodically to ensure that the layers are not damaged.

### SUMMARY

The present invention provides a garment having a moisture barrier layer, a thermal layer and an inspection port disposed in a protected area of a thermal barrier where the inspection port is less likely to be exposed to extreme environments encountered by the user of the garment.

As described in more detail below, the garment disclosed herein has a moisture barrier layer and a thermal barrier layer connected to the moisture barrier layer by at least one binded seam extending along a perimeter portion of the thermal barrier layer and enclosing a space between the moisture barrier layer and the thermal barrier layer. The thermal barrier layer has an inspection port that is spaced apart from the perimeter portion of the thermal barrier layer. The inspection port is therefore spaced apart from the seam around the perimeter of the inner liner that connects the moisture barrier layer and the thermal barrier layer. The space between the moisture barrier layer and the thermal barrier layer is accessible through the inspection port. The inspection port provides a pathway through the thermal barrier layer for visually and physically inspecting the space between the moisture barrier layer and the thermal barrier layer.

According to one aspect of the invention, the garment includes a flap that covers the inspection port. The flap reduces the possibility of water, debris, or other harmful materials seeping through the inspection port to the space between the thermal barrier layer and the moisture barrier layer.

According to another aspect of the invention, the flap includes a releasable fastener that is offset from the inspection port so as to releaseably close the inspection port. This further reduces the likelihood of contaminants entering the space between the moisture barrier layer and the thermal barrier layer. It also reduces the chances of the fastener damaging the integrity of the inner liner fabrics.

In another embodiment, the garment includes a moisture barrier layer and a thermal barrier layer fixedly connected to the moisture barrier layer by at least one seam extending along a perimeter portion of the thermal barrier layer and surrounding a portion of the thermal barrier layer. The at least one seam encloses a space between the moisture barrier layer and the thermal barrier layer. The garment has an inspection port in the thermal barrier layer. The inspection port is located in the portion of the thermal barrier layer surrounded by the at least one seam. The inspection port provides a pathway through the thermal barrier layer to the space between the moisture barrier layer and the thermal barrier layer.

In another embodiment, the garment includes a moisture barrier layer and a thermal barrier layer connected to the moisture barrier layer by at least one seam extending along a perimeter portion of the thermal barrier layer and surrounding a portion of the thermal barrier layer. A bottom extent of the thermal barrier layer and the moisture barrier layer are connected by a waterproof or water-resistant seam portion. The at least one seam encloses a space between the moisture barrier layer and the thermal barrier layer. The garment has an inspection port in the thermal barrier layer. The inspection port is located in the portion of the thermal barrier layer surrounded by the at least one seam. The inspection port provides a pathway through the thermal barrier layer to the space between the moisture barrier layer and the thermal barrier layer.

The foregoing and other features of the invention are hereinafter fully described and particularly pointed out in the claims, the following description and the annexed drawings setting forth in detail several illustrative embodiments of the invention, such being indicative, however, of but a few of the various ways in which the principles of the invention may be employed.

### BRIEF DESCRIPTION OF THE DRAWINGS

In the annexed drawings, which are not necessarily to scale:

FIG. 1 illustrates an exemplary embodiment of an outer shell of a multi-layer garment.

FIG. 2 illustrates an exemplary embodiment of an inner liner of the garment of FIG. 1.

FIG. 3 illustrates an exemplary embodiment of a portion of the thermal barrier layer of the inner liner showing an inspection port.

FIG. 4 illustrates an exemplary embodiment of the inspection port with a flap in the closed position.

FIG. 5 illustrates an exemplary embodiment of the inspection port with the flap in an opened position.

FIG. 6 illustrates an exemplary embodiment of an outer shell of another multi-layer garment.

FIG. 7 illustrates an exemplary embodiment of an inner liner of the garment of FIG. 6.

FIG. 8 illustrates an exemplary embodiment of a portion of the thermal barrier layer of the inner liner showing an inspection port.

FIG. 9 illustrates another exemplary embodiment of a portion of the thermal barrier layer of the inner liner having multiple inspection ports.

### DETAILED DESCRIPTION

The moisture barrier layer and the thermal barrier layer of some firefighter's garments are easily separated from one another to facilitate the inspection of the area between the layers of the liner. For example, the layers may be connected to one another by snaps or zippers. In other garments, the area between the moisture barrier layer and the thermal barrier layer may be inspected through gaps or inspection ports located in the peripheral seams of inner liner that connect the moisture barrier layer and the thermal barrier layer. Such garments, however, provide easily accessible pathways for debris to enter the space between the moisture barrier layer and the thermal barrier. Moreover, the connectors between the different layers of the liner or through the inspection ports are susceptible to leaks and generally weaken the structural integrity of the connection between the moisture barrier layer and the thermal barrier layer.

Given the extreme environments in which the garments are often used, it is likely that such openings between the layers of the liner can become separated, for example, if the garment is caught or snagged on debris while the firefighter is battling a blaze. Often times the firefighter will not realize that the opening has been separated and even if it is realized, the firefighter usually does not have time to reconnect or reclose the inspection port. Consequently, debris and other harmful materials may enter the space between the moisture barrier layer and the thermal barrier layer and may damage the inner liner.

Recognizing the shortcoming and deficiencies of such garments, the garment described herein includes an inspection port located in a protected area of the thermal barrier layer where it is less likely to be exposed to the extreme environments in which firefighters often work. The inspection port described herein is spaced apart from the seams located in the peripheral portion of the inner liner, which connect the moisture barrier layer to the thermal barrier layer. The moisture barrier layer and the thermal barrier layer can therefore be connected to one another with a seam that extends around the entire peripheral portion of the inner liner such that the space between the moisture barrier layer and the thermal barrier layer is completely enclosed. This reduces or eliminates the likelihood of debris, water or other harmful materials entering the space between the moisture barrier layer and thermal barrier layer, and in particular, reduces or eliminates the likelihood of exposure of the space between the layers through the peripheral seams of the liner.

As described in more detail below, the garment disclosed herein has a moisture barrier layer and a thermal barrier layer connected to the moisture barrier layer by at least one seam extending along a perimeter portion of the thermal barrier layer and enclosing a space between the moisture barrier layer and the thermal barrier layer. The thermal barrier layer has an inspection port that is spaced apart from the perimeter portion of the thermal barrier layer. The inspection port is therefore spaced apart from the seam around the perimeter of the inner liner that connects the moisture barrier layer and the thermal barrier layer. The space between the moisture barrier layer and the thermal barrier layer is accessible through the inspection port. The inspection port provides a pathway through the thermal barrier layer for visually and physically inspecting the space between the moisture barrier layer and the thermal barrier layer.

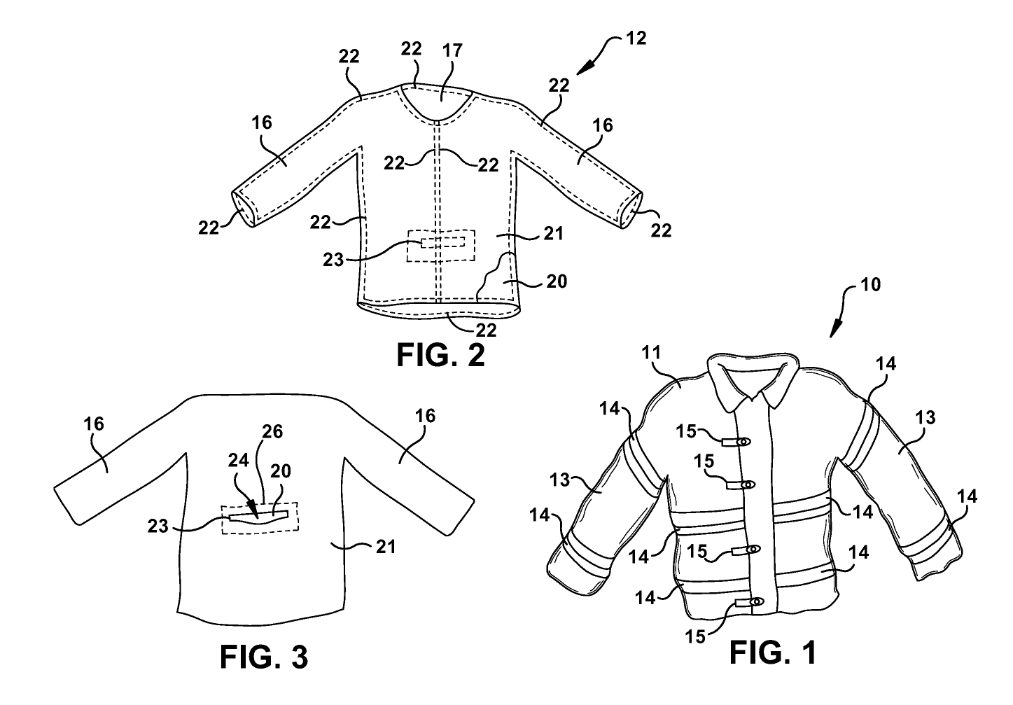

Referring to FIGS. 1 and 2, a multi-layer garment 10 is shown. In the illustrated exemplary embodiment, the multi-layered garment is a jacket that is worn by a firefighter for protection while battling a fire. It will be appreciated that the principles of the disclosed technology are not limited to a garment in the form of a protective jacket. Rather, the disclosed technology may be embodied in the form of other garments, such as pants, as well as in connection with other multi-layered protective items.

The jacket has an outer shell 11 (FIG. 1) and an inner liner 12 (FIG. 2). The outer shell 11 of the jacket 10 has sleeves 13 and a number of reflective stripes 14, typically constructed from highly reflective materials that aid in the identification of the firefighter in dark environments. The jacket 10 is closed by a number of fastening mechanisms 15, such as a zipper, hook and loop, or hook and dee. The outer shell 11 typically is constructed from materials such as a light, strong para-aramid synthetic fiber, for example, a blend of Nomex® and Kelvar® or Polybenzimidazole (also referred to as PBI fiber) and Kelvar®.

Connected to the inside of the outer shell 11 is the inner liner 12. The inner liner 12 also has sleeves 16 for the firefighter's arms and an opening 17 for the firefighter's head. The inner liner 12 has two layers, an outer layer 20 (also referred to as a moisture barrier layer) and an inner layer 21 (also referred to as a thermal barrier layer). The outer and inner layers 20, 21 are connected together by one or more seams extending around a peripheral portion of the inner liner 12, as indicated generally by 22 in FIG. 2.

The moisture barrier layer 20 is configured to reduce or otherwise inhibit the transmission of water or moisture to the thermal barrier layer 21. The moisture barrier layer 20 therefore keeps the firefighter dry and also protects the thermal barrier layer 21 from exposure to fluids such as water. Suitable materials for the moisture barrier layer 20 include fabrics that provide resistance liquid penetration such as Crosstech® or Stedair®, for example.

The inner layer 21 or thermal barrier layer is configured to protect the firefighter from heat exposure and burning. Suitable materials for the thermal barrier layer include a Nomex® and Kevlar® face cloth quilted to a Nomex® non-woven, for example.

The seam 22 connects the layers 20, 21 together in a relatively permanent manner. The space between the inner layer and the outer layer is completely enclosed and substantially inaccessible through the seam 22. As will be appreciated the seam 22 may be a single seam or may be multiple seams connected to one another to substantially completely surround the inner liner 12 such that the space between the moisture barrier layer and the thermal barrier layer is substantially inaccessible through across the seam. In one embodiment, the seam 22 is a binded seam that extends around the bottom of the inner liner 12. The seam can be binded with a water-resistant material (e.g., a waterproof or water-resistant binding tape) sewn to and around edges of the inner liner 12 to effectively seal the bottom perimeter of the jacket to prevent debris and moisture from entering the space between the moisture barrier layer 20 and thermal barrier layer 21. The two-layer inner liner 12 is completely separable from the outer shell 10 by means of snaps and/or hook and loop fasteners.

Completely surrounding the peripheral portion of the inner liner 12 with one or more seams 22 increases the structural integrity of the inner liner 12 and also completely encloses the space between the layers 20, 21. The space between the layers of the inner liner 12 is not accessible through the seams unless the seams are ripped, torn or otherwise separated from one another. Furthermore, there are no inspection ports or other gaps along the seams that may accidentally open to expose the space between the layers to debris, water, or other hazardous materials. The seam 22 therefore provides a more robust and durable connection between the layers 20, 21 than releasable fasteners, such as snaps or hook and loop fasteners. For example, even if an inspection port on the seam is secured closed with a releasable fasteners, such as hook and loop fasteners, it could still open relatively easily as compared to the sewn connection described herein. By completely sewing the layers together in a relatively permanent manner, it is less likely that the space between the layers will be exposed harmful materials or damaged.

In the thermal barrier layer 21 and spaced from the seam 22 around the perimeter portion of the inner liner 12 is an inspection port 23. The inspection port 23 provides a pathway through the thermal barrier layer for inspection of the space (designated generally by reference numeral 24) between the thermal barrier layer and the moisture barrier layer. Although only a single inspection port is illustrated in FIG. 2, it will be appreciated that the inner liner 12 may include additional inspection ports arranged at different locations spaced apart from seam of the garment to facilitate the inspection of the area between the moisture barrier layer and the thermal barrier layer.

With additional reference to FIGS. 3-5, the inspection port 23 is shown in more detail. In one embodiment, the inspection port 23 is elongate in shape and is configured to provide a pathway through the thermal barrier layer 21 to the space 24 between the moisture barrier layer 20 and the thermal barrier layer 21. Through the inspection port 23, the space 24 between the layers 20, 21 of the inner liner 12 can be visually and physically inspected, for example, by viewing the inner liner 12 through the inspection port 23 and/or by turning the inner liner 12 inside out by pulling the material through the inspection port 23. The inspection port 23 may be about 5-8 inches in length, although it will be appreciated that the inspection port 23 can be longer or shorter in length as may be desired.

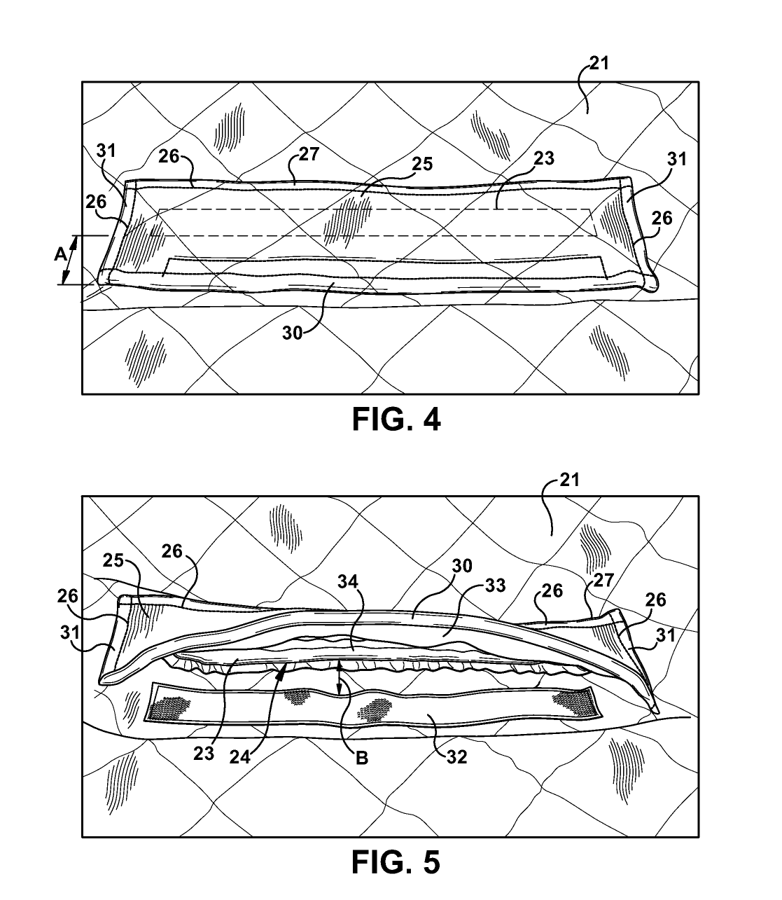

As shown best in FIG. 4, the inspection port 23 is covered with a flap 25. The flap 25 is an elongate shape that covers the inspection port 23 and protects it from the surrounding environment. Although illustrated as a rectangular shape, it will be appreciated that flap 25 may be another shape to cover the inspection port 23, for example, the flap may have an ovular or other shape.

The flap 25 can be made from a thermally protective material, for example, the same material as the thermal barrier layer 21. The flap 25 reinforces the thermal barrier layer 21 in the region of the inspection port 23. Thus, even though the inspection port 23 provides an opening through the thermal barrier layer 21, the firefighter is not at risk for burning or other injury from heat that may be transmitted through the inspection port 23 because with the flap 25, the firefighter's body is completely surrounded by the thermal barrier layer 21 or thermally protective materials (e.g., there are no gaps in the thermal barrier layer).

The flap 25 is connected to the thermal barrier 21 with a seam 26 such that a first edge 27 (e.g., an upper edge) of the flap 25 is disposed above the inspection port 23 and the second edge 30 (e.g., the lower edge) of the flap 25 is disposed below the inspection port 23 (e.g., the flap 25 is arranged such that the upper edge 27 and lower edge 30 are disposed on opposite sides of the inspection port 23).

As shown in FIG. 4, the flap 25 has an upper edge 27 and a lower edge 30 that are connected to one another by a pair of side edges 31. The seam 26 connecting the flap 25 to the thermal barrier layer 21 extends around a peripheral portion of the flap 25. The upper edge 27 is connected to the thermal barrier layer by a seam 26 that extends along the upper peripheral portion of the flap 25. Likewise, the side edges of the flap 25 are connected to the thermal layer by seams 26 that extend along the peripheral portion of the side edges 31. The seam 26 therefore partially surrounds the inspection port 23. As will be appreciated, the seam 26 may be a single seam or multiple seams that are interconnected to one another at corners of the flap 25.

The flap 25 may be connected to the thermal barrier layer 21 such that the upper edge 27 of the flap 25 is closer to the inspection port 23 than the lower edge 30 of the flap 25. The side edges 31 of the flap 25 also are connected to the thermal barrier layer 21 in such a manner that a portion of the side edges 31 and the seam 26 that connects the side edges 31 to the thermal barrier layer 21 extend below the inspection port 23, for example, as indicated by length “A” in FIG. 4.

By partially surrounding the inspection port 23 with the flap 25, the flap 25 tends to remain in the closed position. This aids in the protection of the inspection port 23 from accidental exposure to the outside environment, and therefore reduces the likelihood that the space 24 between the moisture barrier 20 layer and the thermal barrier layer 21 can be compromised or otherwise damaged.

The one edge (e.g., the bottom or lower edge 30) of the flap 25 is not sewn to the thermal barrier layer 21. The bottom edge 30 can therefore be lifted or opened to provide access to the inspection port 23. The flap 25 can be closed, as shown in FIG. 4, or opened, as shown in FIG. 5. In the open position, the inspection port 23 is accessible and the space 24 between the moisture barrier layer 20 and the thermal barrier layer 21 can be inspected.

The bottom edge 30 of the flap 25 is held in the closed position with a releasable fastener, for example, a hook 32 and loop 33 fastener. The hook and loop fastener 32, 33 is spaced or offset from the inspection port 23 such that the flap 25 extends over and covers the inspection port 23 when it is closed (e.g., when the hook and loop are engaged with one another). Securing the flap 25 in the closed position further protects the inspection port 23 and isolates it from the surrounding environment. This further reduces the likelihood that debris or other harmful material can enter the inspection port 23 into the space 24 between the moisture barrier layer 20 and thermal barrier layer 21, causing damage to one or both layers, and also reinforces the thermal protection provided by the thermal barrier layer 21.

In some circumstances, it may be possible for the hook portion 32 of the releasable fastener pass through the inspection port 23 and rub against the moisture barrier layer 20. This may delaminate or otherwise damage the moisture barrier layer 20, making it less effective or less moisture resistant. The loop portion 33 of the releasable fastener typically is softer and less abrasive than the hook portion 32, and therefore the loop portion 33 is less likely to damage the moisture barrier layer 20 if it passes through the inspection port 23 and rubs against the moisture barrier layer 20.

Therefore, in a preferred embodiment, to reduce the likelihood of the hook portion 32 of the releasable fastener damaging the moisture barrier layer 20, the hook portion 32 is attached to the thermal barrier layer 21 and the loop portion 32 is attached to the flap 25. The hook portion 32 thus can be arranged such that it faces towards the flap 25 in the direction of the firefighter's body when the jacket 10 is being worn, and the softer loop portion 33 can be arranged such that it faces in the direction of the thermal barrier layer 21. In the event that the loop 33 were to rub against the moisture barrier layer 20, it would be less likely to cause damage to the layer.

The releasable fastener also may be offset below the inspection port 23, for example, as indicated generally by “B” in as shown in FIG. 5. The offset B may further reduce the likelihood that the hook portion 32 of the releasable fastener will rub against the moisture barrier layer 20. In one embodiment, the releasable fastener is offset is about 1-2 inches below from the inspection port 23, however, other arrangements are also possible.

This arrangement of the releasable fastener and the hook and loop portions 32, 33 disclosed herein advantageously protects the space 24 between the moisture barrier layer 20 and the thermal barrier layer 21. For example, if the inspection port 23 were located in or along the peripheral portions of the seams of the inner liner, it is more likely that the hook portion 32 of the releasable fastener would rub against and damage the moisture barrier layer. By spacing the releasable fastener, and in particular the loop portion 32, away from the inspection port 23, and by arranging the hook portion 32 of the releasable fastener to face in the direction of the wearer, rather than in the direction of the moisture barrier layer, the moisture barrier layer 20 can be protected and the likelihood of damage reduced.

The inspection port 23 also may be surrounded by a binding material 34, such as a waterproof or water-resistant binding tape. The binding material 34 reinforces and strengthens the inspection port 23, which reduces the likelihood of the inspection port 23 tearing or ripping. If the inspection port 23 is exposed to moisture, the binding tape 34 also inhibits the absorption of the moisture into the thermal barrier layer 21.

The seam 22 surrounding the inner liner 12 also may incorporate binding material. The binding material inhibits the absorption of moisture into the thermal barrier layer and the space between the moisture barrier layer 20 and thermal barrier layer 21. By surrounding the inner liner 12 with the binding tape, and by locating the inspection port 23 away from the seam surrounding the inner liner 12, the likelihood that water will be absorbed into the thermal barrier layer 21 or space 24 between the thermal barrier layer 21 and moisture barrier layer 20 is reduced over arrangements in which the inspection port 23 is located on or as part of the peripheral seams of the inner liner 12.

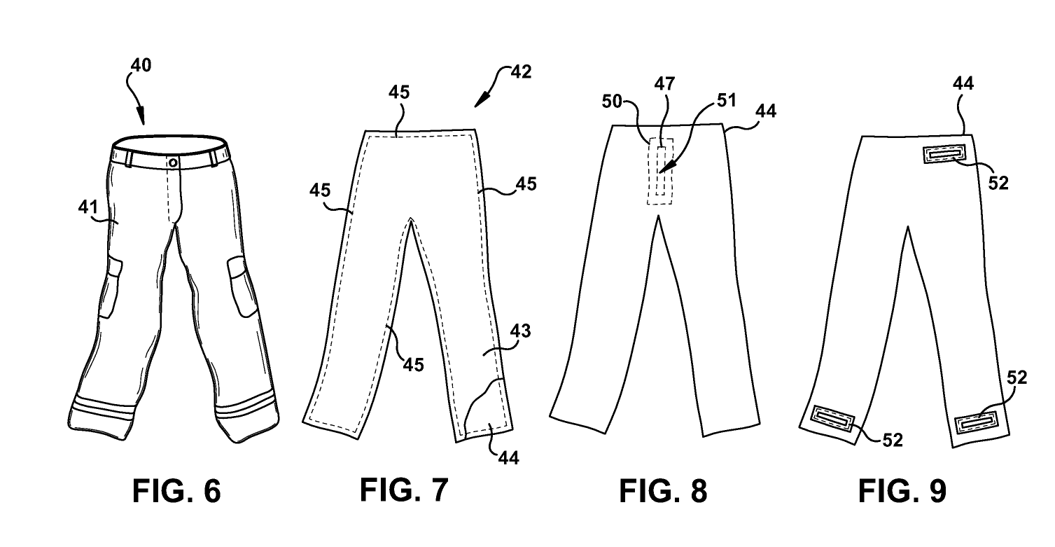

Referring to FIGS. 6-9, another embodiment of a garment with an inspection port in the thermal barrier layer is shown. The garment of FIGS. 6-9 is a pair of pants 40, for example, firefighter's pants. The pants include an outer shell 41, shown in FIG. 6 and an inner liner 42, shown in FIG. 7. The inner liner 42 includes an outer moisture barrier layer 43 and an inner thermal barrier layer 44. The moisture barrier layer 43 and the thermal barrier layer 44 are connected to one another by one or more seams 45 extending along the peripheral portion of the inner liner 42 and substantially enclosing a space 46 between the moisture barrier layer 43 and the thermal barrier layer 44. As described above with respect to the jacket, the seam may include a reinforcement material to inhibit the transmission of water across the seam and into the space between the moisture barrier layer and thermal barrier layer where it may be absorbed into the thermal barrier layer.

The front of the thermal barrier layer 44 is shown in FIG. 8. Located on the thermal barrier layer 44 and spaced apart from the seam 45 in the perimeter portion of the inner liner 42 is an inspection port 47. The inspection port 47 may, for example, be located in the fly or crotch area of the pants and formed substantially as described above with respect to the inspection port 23 in the jacket 10. For brevity, the details of the inspection port 47, corresponding flap 50 and releasable fastener (not shown), etc., will not be repeated. The inspection port 47 provides a pathway through the thermal barrier layer 44 such that the space 51 between the thermal barrier layer and the moisture barrier layer can be inspected. The inspection port may be vertically oriented, as shown in FIG. 8 or horizontally oriented as shown in FIG. 9.

Also, as shown in FIG. 9, the thermal barrier layer may have multiple inspection ports (indicated generally by 52) located in different areas of the garment spaced apart from the seam 45. For example, the thermal barrier layer 44 may include inspection ports near the bottom of each pant leg as shown in FIG. 9. It also will be appreciated that multiple inspection ports may be located in different areas of the jacket described above. Multiple inspection ports may facilitate inspection of the space between the moisture barrier layer and the thermal barrier layer, for example, by providing easier access to the arms or legs of the garment.

Although described primarily with respect to protective clothing for firefighters, it should be appreciated that the concepts described herein are equally applicable to other apparel or garments.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

Furthermore, directional modifiers (e.g., upper, top, lower, bottom, above, below, left-hand, right-hand, etc.) are used only for ease in explanation in connection with the illustrated orientation and do not, unless otherwise indicated, limit the elements to any specific orientation.

What is claimed is:

1. A garment comprising:
a moisture barrier layer;
a thermal barrier layer connected to the moisture barrier layer by at least one seam extending along a perimeter portion of the thermal barrier layer and enclosing a space between the moisture barrier layer and the thermal barrier layer; and
an inspection port in the thermal barrier layer, the inspection port spaced apart from the perimeter portion of the thermal barrier layer, wherein the space between the moisture barrier layer and the thermal barrier layer is accessible through the inspection port.

2. The garment of claim 1, further comprising a flap covering the inspection port, wherein the flap is connected to the thermal barrier layer by at least one seam extending at least partially along a peripheral portion of the flap.

3. The garment of claim 2, wherein the peripheral portion of the flap includes an upper edge connected to a lower edge by a pair of side edges extending between the upper edge and the lower edge, wherein the upper edge is connected to the thermal barrier layer by the at least one seam extending along the peripheral portion of the flap.

4. The garment of claim 3, wherein the side edges of the flap are connected to the thermal barrier layer by the at least one seam extending along the peripheral portion of the flap.

5. The garment of claim 4, wherein the upper edge of the flap is disposed above the inspection port and the lower edge of the flap is disposed below the inspection port.

6. The garment of claim 4, wherein the upper edge and the lower edge of the flap are generally parallel to the inspection port and wherein the upper edge and the lower edge of the flap are vertically offset on opposite sides of the inspection port.

7. The garment of claim 6, further comprising a releasable fastener including a loop disposed on the lower edge of the flap and directed towards the moisture barrier layer, and a hook disposed on the thermal barrier layer for engaging the loop to secure the flap to the thermal barrier layer.

8. The garment of claim 2, further comprising binding along an edge of the inspection port.

9. The garment of claim 8, wherein the binding is waterproof or water-resistant binding tape.

10. The garment of claim 2, wherein the flap and the thermal barrier layer are composed of the same material.

11. The garment of claim 2, further comprising a releasable fastener that is configured to releasably hold the flap in a closed position.

12. The garment of claim 11, wherein the releasable fastener includes a loop disposed on the flap and a hook disposed on the thermal barrier layer.

13. The garment of claim 12, wherein the loop is disposed to face in the direction of the moisture barrier layer and the hook is disposed to face in a direction away from the moisture barrier layer.

14. The garment of claim 12, wherein the loop and flap are offset from the inspection port.

15. The garment of claim 1, further comprising binding tape extending along the perimeter of the thermal barrier layer and connected to the thermal barrier layer and moisture barrier layer by the seam extending along the perimeter of the thermal barrier layer.

16. The garment of claim 14, wherein the binding tape is water proof or water resistant material.

17. A garment comprising:
a moisture barrier layer;
a thermal barrier layer fixedly connected to the moisture barrier layer by at least one seam extending along a perimeter portion of the thermal barrier layer and surrounding a portion of the thermal barrier layer, wherein the at least one seam encloses a space between the moisture barrier layer and the thermal barrier layer; and
an inspection port in the thermal barrier layer, the inspection port located in the portion of the thermal barrier layer surrounded by the at least one seam, wherein the inspection port provides a pathway through the thermal barrier layer to the space between the moisture barrier layer and the thermal barrier layer.

18. A garment comprising:
a moisture barrier layer;
a thermal barrier layer connected to the moisture barrier layer by at least one seam extending along a perimeter portion of the thermal barrier layer and surrounding a portion of the thermal barrier layer, wherein a bottom extent of the thermal barrier layer and the moisture barrier layer are connected by a waterproof or water-resistant seam portion, and wherein the at least one seam encloses a space between the moisture barrier layer and the thermal barrier layer; and
an inspection port in the thermal barrier layer, the inspection port located in the portion of the thermal barrier layer surrounded by the at least one seam, wherein the inspection port provides a pathway through the thermal barrier layer to the space between the moisture barrier layer and the thermal barrier layer.
